(19) United States
(12) Patent Application Publication
(10) Pub. No.: US 2024/0369833 A1
(43) Pub. Date: Nov. 7, 2024

(54) HEAD-UP DISPLAY SYSTEM AND VEHICLE

(71) Applicant: GOERTEK OPTICAL TECHNOLOGY CO., LTD, Weifang, Shandong (CN)

(72) Inventors: En ZHAO, Weifang, Shandong (CN); Yi RAO, Weifang, Shandong (CN); Xiao WU, Weifang, Shandong (CN)

(21) Appl. No.: 18/689,646

(22) PCT Filed: Jun. 21, 2022
(86) PCT No.: PCT/CN2022/100101

§ 371 Date: Mar. 6, 2024

(30) Foreign Application Priority Data
Nov. 23, 2021 (CN) 202111393181.5

(51) Int. Cl. G02B 27/01; G02B 6/293

(52) U.S. Cl. CPC G02B 27/0101; G02B 6/29301; G02B 6/29328; G02B 2027/0123; G02B 2027/0196

(57) ABSTRACT

A head-up display system and a vehicle are disclosed, the head-up display system comprises a light source and an optical guide assembly (1); an incident light emitted from the light source is incident into the optical guide assembly (1); the optical guide assembly (1) receives the incident light and outputs an exit light; the optical guide assembly (1) comprises at least two optical guides, and the incident light is coupled in and coupled out by the at least two optical guides and then is exited to form at least two divided field of views. By replacing the light guide (4) in the prior art with the optical guide assembly (1), the difficulty for processing a large area optical guide is effectively reduced, and a purpose of expanding an angle of field of view of an HUD and an eyebox is achieved.

### TECHNICAL FIELD

The present disclosure relates to a technical field of head-up display, and more particularly, to a head-up display system and a vehicle.

### BACKGROUND

A head-up display system (HUD for short, Head-up Display, also be known as a head up display system) may project information such as speed information and navigation information and the like onto a photoelectric display device on a windshield, for forming an image in front of the windshield. Thus, a driver can see the navigation information and the speed information without turning his head or lowering his head, for minimizing distraction of the driver's attention and improving safety during driving. At present, in AR-HUD applications required by a large field of view and a large virtual image distance, a HUD system with an optical guide as a core optical component gradually enters the public vision. However, for the optical guide HUD system having the large field of view, due to its very large area, especially for surface relief gratings, the existing processing technology only supports wafers with sizes smaller than or equal to 12 inches, but for wafers with sizes exceeding the restriction of 12 inches, it is difficult to process and has a high cost.

In view of this, it is necessary to provide a new type of head-up display system and a vehicle, which can effectively reduce difficulty for processing without reducing a performance of the optical guide HUD, in order to solve or at least improve the above-mentioned technical defects.

### SUMMARY

A main purpose of the present disclosure is to provide a head-up display system and a vehicle, intended to solve the technical problems of large volume and high difficulty for processing of the optical guide in the head-up display system of the prior art.

To achieve the above purpose, according to one aspect of the present disclosure, the present disclosure provides a head-up display system, comprising a light source and an optical guide assembly,
wherein an incident light emitted from the light source is incident into the optical guide assembly;
wherein the optical guide assembly receives the incident light and outputs an exit light, and wherein the optical guide assembly comprises at least two optical guides, and the incident light is coupled in and coupled out by the at least two optical guides and then is exited to form at least two divided field of views.

Optionally, the at least two optical guides comprise a coupling in area and a coupling out area, respectively.

Optionally, the head-up display system further comprises a transmission-reflection plate for reflecting the exit light to a human eye.

Optionally, the exit light is reflected by the transmission-reflection plate to form at least two eyebox areas.

Optionally, the optical guide assembly comprises a first optical guide and a second optical guide, the first optical guide and the second optical guide are horizontally disposed below a side of the transmission-reflection plate facing a human eye, and
wherein, the incident light comprises a first incident light and a second incident light, the first incident light passes through the first optical guide to form a first divided field of view, and the second incident light passes through the second optical guide to form a second divided field of view.

Optionally, the optical guide assembly comprises a third optical guide and a fourth optical guide, the third optical guide and the fourth optical guide are vertically disposed below a side of the transmission-reflection plate facing a human eye, and
wherein the incident light comprises a third incident light and a fourth incident light, the third incident light passes through the third optical guide to form a third divided field of view, and the fourth incident light passes through the fourth optical guide to form a fourth divided field of view.

Optionally, the first optical guide and the second optical guide form a central zero field of view together; and/or
the third optical guide and the fourth optical guide form a central zero field of view together. Optionally, the optical guide assembly comprises an optical guides array, the optical guides array comprises a plurality of sub optical guides arranged in an array along a first direction and/or a second direction.

Optionally, the optical guides array has a multi-layered structure.

Optionally, two sub optical guides adjacent to each other in the optical guides array form an overlapping field of view.

Optionally, two adjacent optical guides contact with each other or a gap is between the two adjacent optical guides.

Optionally, the coupling in area and/or the coupling out area are one-dimensional gratings or two-dimensional gratings.

Optionally, the optical guides further comprises a turning area, the incident light passes through the coupling in area, the turning area and the coupling out area to form the exit light.

Optionally, the head-up display system has one light source or a plurality of light sources, and wherein when the head-up display system has a plurality of light sources, the plurality of light sources are disposed corresponding to the optical guides respectively.

The present disclosure further provides a vehicle, the vehicle comprises the head-up display system and a housing, and the transmission-reflection plate is a vehicle windshield.

In the technical solution of the present disclosure, by replacing the light guide in the prior art with the optical guide assembly, the difficulty for processing a large-area light guide is effectively reduced, and a purpose of expanding an angle of field of view and an eyebox of HUD is achieved. The optical guide assembly comprises at least two optical guides, the at least two optical guides are horizontally or vertically disposed below the side of the transmission-reflection plate facing the human eye. The incident light emitted from the light source is coupled in and coupled out by at least two optical guides and then is exited to form at least two divided field of views, and the at least two divided field of views form a total field of view of the head-up display system. The head-up display system and the vehicle provided by the present disclosure can achieve a large field of view, a large eyebox, and can effectively reduce the difficulty for processing while ensuring the performance of the optical guide HUD.

### BRIEF DESCRIPTION OF DRAWINGS

In order to more clearly illustrate the embodiments of the technical solutions in the present disclosure or the prior art, the drawings required to be used for the content of the embodiments or the prior art will be briefly introduced in the following. Obviously, the drawings in the following description are merely some embodiments of the present disclosure, and for those of ordinary skill in the art, other drawings can also be obtained from the provided drawings without any creative effort.

FIG. 1 is a schematic structural diagram of a head-up display system according to the prior art;

FIG. 2 is a schematic structural diagram of an embodiment of the head-up display system according to the present disclosure;

FIG. 3 is a schematic structural diagram of another embodiment of the head-up display system according to the present disclosure;

FIG. 4 is a schematic structural diagram of further another embodiment of the head-up display system according to the present disclosure;

FIG. 5 is a schematic diagram of another structure of the optical guide assembly different from the structure of FIG. 4;

FIG. 6 is a schematic structural diagram of the optical guide according to the embodiment of the present disclosure; and

FIG. 7 is a schematic diagram of another structure of the optical guide according to the embodiment of the present disclosure.

### Explanation of Reference Numerals are as Below

1. optical guide assembly; 11. first optical guide; 111. coupling in area; 112. coupling out area; 113. turning area; 12. second optical guide; 13. third optical guide; 14. fourth optical guide; 15. optical guides array; 151. first layer optical guides array; 1511. sub optical guide; 152. second layer optical guides array; 2. transmission-reflection plate; 3. human eye; 4. optical guide.

The purpose implementation, functional features, and advantages of the present disclosure will be further explained in conjunction with the embodiments with reference to the accompanying drawings.

### DETAILED DESCRIPTIONS

Technical solutions of embodiments of the present disclosure will be clearly and completely described below with reference to the drawings in the embodiments of the present disclosure. Obviously, the described embodiments are only a part of the embodiments of the present disclosure, rather than all the embodiments. Based on the embodiments in the present disclosure, all other embodiments obtained by those of ordinary skill in the art without creative efforts shall fall within the protection scope of the present disclosure.

It should be noted that all directional indications (such as up, down . . . ) in the embodiments of the present disclosure are only used to explain the relative positional relationships and movement conditions, etc. among the components in a specific posture (as shown in the drawings), and if the specific posture changes, the directional indication will also be changed accordingly.

In addition, the descriptions such as “first”, “second”, etc. in the present disclosure are only for descriptive purposes, and should not be construed as indicating or implying their relative importance or implicitly indicating the quantity of indicated technical features. Thus, the features defined with “first”, “second”, etc. may explicitly or implicitly comprise at least one of these features.

Moreover, the technical solutions of the various embodiments of the present disclosure can be combined with each other, but must be based on the fact that ordinary technical personnel in the art can achieve them. When the combination of technical solutions conflicts or cannot be achieved, it should be considered that the combination of such technical solutions does not exist and is not within the scope of protection required by the present disclosure.

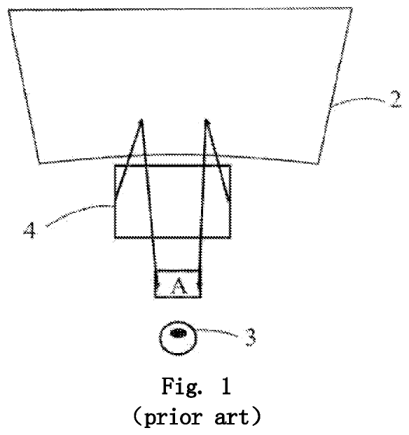

FIG. 1 shows a structure of a head-up display system in the prior art, which comprises a light source, an optical guide 4 and a transmission-reflection plate 2. An incident light emitted from the light source is incident into the optical guide 4, the optical guide 4 receives the incident light and outputs an exit light. The incident light is coupled in and coupled out by the optical guide 4 and then is exited to form a field of view A. However, for the traditional optical guide HUD, in order to achieve a large field of view, the required area of the optical guide may be very large, especially for surface relief gratings, the existing processing technology only supports wafers with sizes smaller than or equal to 12 inches, but for wafers with sizes exceeding the restriction of 12 inches, it is difficult to process and has a high cost. Therefore, it is necessary to provide a new type of head-up display system and a vehicle, which can effectively reduce difficulty for processing without reducing a performance of the optical guide HUD, in order to solve or at least improve the above-mentioned technical defects. It is worth noting that the optical guide is an optical waveguide.

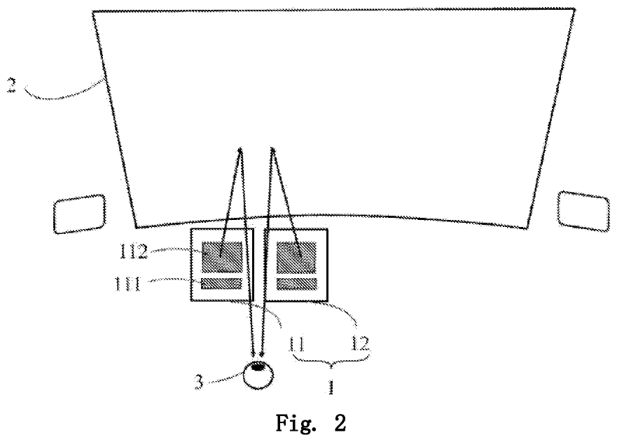

The present disclosure provides a head-up display system, referring to FIG. 2, comprising a light source and an optical guide assembly 1;
an incident light emitted from the light source is incident into the optical guide assembly 1,
the optical guide assembly 1 receives the incident light and outputs an exit light, and the optical guide assembly 1 comprises at least two optical guides, and the incident light is coupled in and coupled out by the at least two optical guides and is exited to form at least two divided field of views.

As shown in an embodiment provided by FIG. 2, the optical guide assembly 1 comprises two optical guides, the two optical guides comprise a coupling in area and a coupling out area respectively.

The head-up display system further comprises a transmission-reflection plate 2, the transmission-reflection plate 2 is used to reflect the exit light to a human eye 3, and the exit light is reflected by the transmission-reflection plate 2 to form at least two eyebox areas.

The head-up display system is disposed in the driver's cabin of the vehicle, which is used to project important driving information such as speed information and navigation information onto a windshield in front of the driver to form a virtual image, so that the driver can try to see the important driving information such as the speed information and the navigation information without lowering his head or turning his head. The light source of the head-up display system may be a projection light machine, which is used to incident the incident light emitted from the light source into the optical guide assembly 1. The optical guide assembly 1 receives the incident light and outputs the exit light, and the transmission-reflection plate 2 reflects the exit light to the human eye 3. The optical guide assembly 1 of the head-up display system comprises at least two optical guide components, and the optical guides may be combined together to achieve the purpose of expanding the field of view and the eyebox. Further, by replacing the light guide 4 of the prior art with the optical guide assembly 1, the difficulty for processing the large area optical guide is effectively reduced. Especially, the existing relief grating processing technology only supports wafers with sizes smaller than or equal to 12 inches, but for wafers with sizes exceeding the restriction of 12 inches, it is difficult to process and has a high cost. For the optical guide HUD having the large field of view, when the field of view exceeds 10°, the size of the wafer required for preparing the optical guide generally exceeds 12 inches, which provides a huge challenge to the implementation of the optical guide HUD having the large field of view. In the above embodiment, by adopting the form of the combination of waveguides, the combined field of view and the combined eyebox are achieved, and the production and even mass production of the optical guide HUD having the large field of view become possible.

The optical guide assembly 1 in FIG. 2 comprises a first optical guide 11 and a second optical guide 12, the first optical guide 11 and the second optical guide 12 are horizontally disposed below the side of the transmission-reflection plate 2 facing the human eye 3. The incident light comprises a first incident light and a second incident light, and the first incident light passes through the first optical guide 11 to form a first divided field of view, and the second incident light passes through the second optical guide 12 to form a second divided field of view. The exit light comprises a first exit light and a second exit light. The first exit light is reflected by the transmission-reflection plate 2 and then is exited to form a first eyebox area, and the second exit light is reflected by the transmission-reflection plate 2 and then is exited to form a second eyebox area. The first divided field of view provided by the first optical guide 11 and the second divided field of view provided by the second optical guide 12 form a total field of view together, and the sum of the eyebox areas provided by the first optical guide 11 and the second optical guide 12 is the final eyebox area. The optical guide assembly can provide a larger field of view and a larger eyebox compared to the optical guide component of the prior art, and also can effectively reduce the difficulty for processing the large area optical guide. For example, for a 12° angle of field of view, a 15 inches wafer is required to be used as the base to prepare one piece of optical guide sample. For the optical guide assembly in this embodiment, two optical guides can be used to combine a 12° angle of field of view, and one optical guide is reduced to 7.5 inches in size, in this way, it can be adapted to the existing mature process for 12 inches wafer. The above content is only an example of the head-up display system, and there is no restriction on the number and position of optical guides.

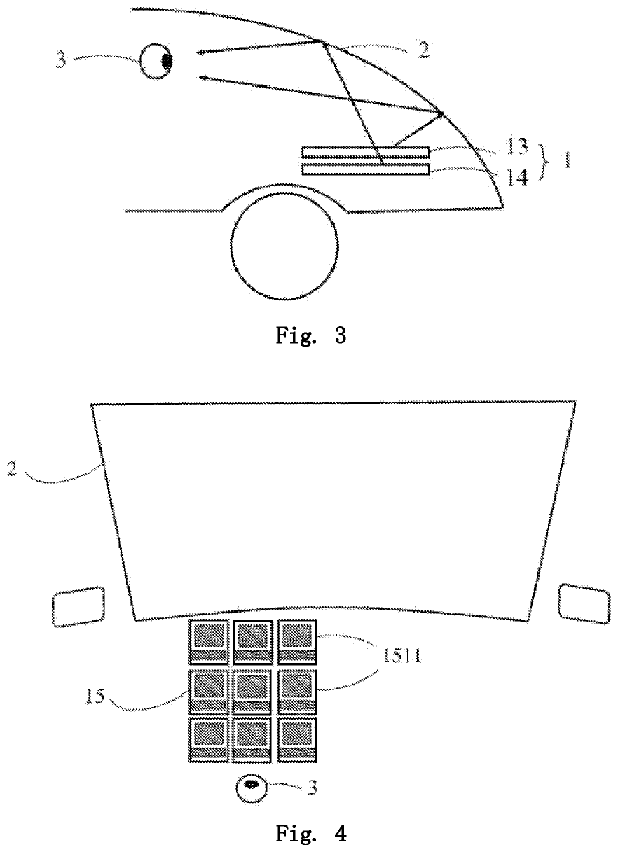

In an embodiment, please refer to FIG. 3, the optical guide assembly 1 comprises a third optical guide 13 and a fourth optical guide 14, the third optical guide 13 and the fourth optical guide 14 are vertically disposed below the side of the transmission-reflection plate 2 facing the human eye 3. The incident light comprises a third incident light and a fourth incident light, the third incident light passes through the third optical guide 13 to form a third divided field of view, and the fourth incident light passes through the fourth optical guide 14 to form a fourth divided field of view. The exit light comprises a third exit light and a fourth exit light, and the third exit light is reflected by the transmission-reflection plate 2 and then is exited to form a third eyebox area, and the fourth exit light is reflected by the transmission-reflection plate 2 and then is exited to form the fourth eyebox area. The third divided field of view provided by the third optical guide 13 and the fourth field of view provided by the fourth optical guide 14 form the total field of view together, and the sum of the eyebox areas provided by the third optical guide 13 and the fourth optical guide 14 is the final eyebox area. Similarly, each of the two optical guides may have an area of less than 12 inches, which can be adapted to the existing mature processes and will not be repeated herein. The above is only an example of a head-up display system, and there is no restriction on the number and position of the optical guides.

In the above two embodiments, the first optical guide 11 and the second optical guide 12 form a central zero field of view together, and/or the third optical guide 13 and the fourth optical guide 14 form a central zero field of view together, so that the screen of the total field of view does not occur a circumstance where the central field of view is interrupted.

In one embodiment, referring to FIGS. 4 and 5, the optical guide assembly 1 comprises an optical guides array 15, the optical guides array 15 comprises a plurality of sub optical guides 1511 arranged in an array along the first direction and/or the second direction. The optical guides array 15 in FIG. 4 comprises three sub optical guides 1511 in the first direction and three sub optical guides 1511 in the second direction, that is, 3×3 arrays. Each sub optical guide 1511 provides one sub field of view, and the sum of the sub fields provided by nine sub optical guides 1511 is the total field of view, and each sub optical guide 1511 provides one eyebox area, the sum of the eyebox areas provided by the nine sub optical guides 1511 is the final eyebox area. It can be seen from the above that, the optical guides array can provide a larger field of view and a larger eyebox, and can effectively reduce the difficulty for processing the large-area optical guides. For example, for two optical guides, the supported maximum field of view is 18°, and when the field of view exceeds 18°, the area of one waveguide may also exceed 12 inches. I In this case, for the combination form of the optical guides array, the area of the waveguide is smaller, therefore, under the condition of providing a larger field of view, such as a field of view larger than or equal to 30°, a processing process for wafer of 12 inches can still be used, so that it easy to achieve mass production of the optical guide HUD. The above content is only an embodiment of a head-up display system, and there is no restriction on the number and position of sub optical guides, and the form of optical guides array may be n×m, wherein n and m are both positive integers, for example, 3×2, 2×3, 4×4 and the like.

FIG. 5 illustrates another structure of the optical waveguide assembly different from the structure of the embodiment of FIG. 4. The optical guides array 15 may have a multi-layered structure, as shown in FIG. 5, the optical guides array 15 may comprise a first optical guides array layer 151 and a second optical guides array layer 152, and is disposed below the side of the transmission-reflection plate 2 facing the human eye 3 by a double-layer structure. Similarly, it is possible to achieve a larger field of view and a larger eyebox, can be adapted to the current mature processes, which will not be further repeated herein. The above content is only an example of the head-up display system, and there is no restriction on the number of layers and positions of the optical guides in the array. In addition, in the above embodiment, the adjacent two sub optical guides 1511 in the optical guides array 15 form an overlapping field of view.

In one embodiment, two adjacent optical guides contact with each other or a gap is between the two adjacent optical guides.

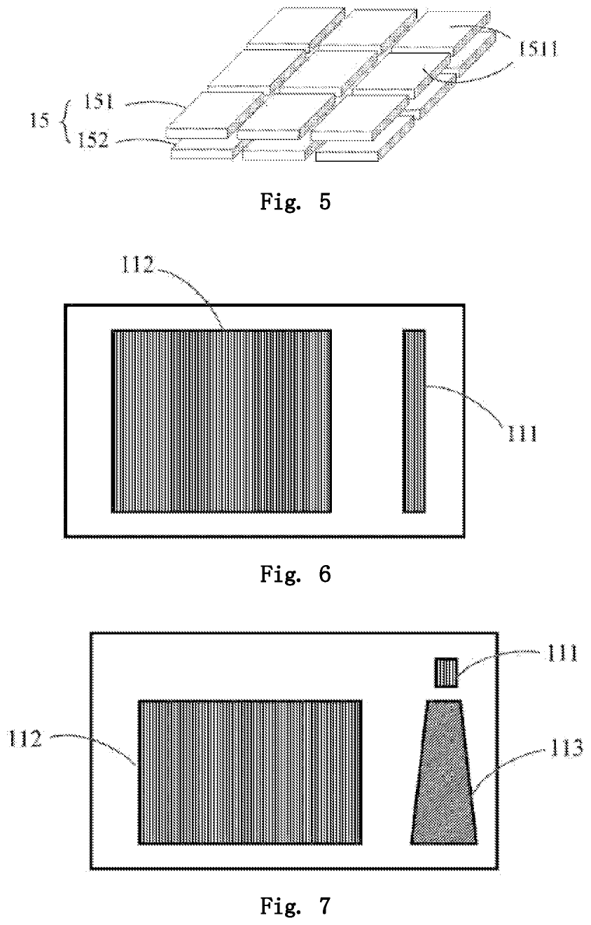

In an embodiment, referring to FIGS. 6 and 7, there may be various types and structures of the optical guides, as shown in FIGS. 6, the structure of the optical guide may comprise a coupling in area 111 and a coupling out area 112, and the incident light passes through the coupling in area 111 and the coupling out area 112 to form an exit light. As shown in FIG. 7, the structure of the optical guide may further comprise a coupling in area 111, a turning area 113 and a coupling out area 112, and the incident light passes through the coupling in area 111, the turning area 113 and the coupling out area 112 to form an exit light. It is worth noting that there is no restriction on the shape and type of the optical guides and gratings mentioned in the above embodiments, the types of gratings may be blazed gratings, tilted gratings, rectangular gratings, etc. The types of optical guides may comprise geometric optical guides, surface relief grating waveguides, holographic grating waveguides, etc.

In one embodiment, the coupling in area 111 and/or the coupling out area 112 may be a one-dimensional or two-dimensional grating, achieving one-dimensional dilation or two-dimensional dilation, which will not be specifically restricted herein.

In one embodiment, the head-up display system has one light source or a plurality of light sources. On the one hand, when the head-up display system has one light source, the incident light emitted from the one light source is incident into the optical guide assembly 1, the optical guide assembly 1 receives the incident light and outputs the exit light, and the transmission-reflection plate 2 reflects the emitted light to the human eye 3. On the other hand, when the head-up display system has a plurality of light sources, the plurality of light sources are disposed corresponding to the plurality of optical guides respectively, the plurality of light sources emit the incident light respectively and the incident light is incident into the plurality of optical guides respectively, the optical guide assembly 1 receives the incident light and outputs the exit light, and the transmission-reflection plate 2 reflects the exit light to the human eye 3.

The present disclosure also provides a vehicle, the vehicle comprises the head-up display system, and the transmission-reflection plate is a vehicle windshield. Since the vehicle comprises all embodiments of the technical solutions of the above-described head-up display system, it has at least all the beneficial effects achieved by all the above-described embodiments, and will not be repeated herein.

The above are only preferred embodiments of the present disclosure, and do not limit the patent scope of the present disclosure. Under the inventive concept of the present disclosure, equivalent structural transformations made using the contents of the description and its accompanying drawings of the present disclosure, or direct/indirect applications in other related technical fields, are included in the protection scope of the present disclosure.

1. A head-up display system, comprising a light source and an optical guide assembly,
wherein an incident light emitted from the light source is incident into the optical guide assembly,
wherein the optical guide assembly receives the incident light and outputs an exit light, and
wherein the optical guide assembly comprises at least two optical guides, and the incident light is coupled in and coupled out by the at least two optical guides and then is exited to form at least two divided field of views.

2. The head-up display system of claim 1, wherein the at least two optical guides comprise a coupling in area and a coupling out area, respectively.

3. The head-up display system of claim 1, wherein the head-up display system further comprises a transmission-reflection plate for reflecting the exit light to a human eye.

4. The head-up display system of claim 3, wherein the exit light is reflected by the transmission-reflection plate to form at least two eyebox areas.

5. The head-up display system of claim 1, wherein the optical guide assembly comprises a first optical guide and a second optical guide, the first optical guide and the second optical guide are horizontally disposed below a side of the transmission-reflection plate facing a human eye,
wherein the incident light comprises a first incident light and a second incident light, the first incident light passes through the first optical guide to form a first divided field of view, and the second incident light passes through the second optical guide to form a second divided field of view, and
wherein the first optical guide and the second optical guide form a central zero field of view together.

6. The head-up display system of claim 1, wherein the optical guide assembly comprises a third optical guide and a fourth optical guide, the third optical guide and the fourth optical guide are vertically disposed below a side of the transmission-reflection plate facing a human eye, and
wherein the incident light comprises a third incident light and a fourth incident light, the third incident light passes through the third optical guide to form a third divided field of view, and the fourth incident light passes through the fourth optical guide to form a fourth divided field of view.

7. The head-up display system of claim 6,
wherein the third optical guide and the fourth optical guide form a central zero field of view together.

8. The head-up display system of claim 1, wherein the optical guide assembly comprises an optical guides array, the optical guides array comprises a plurality of sub optical guides arranged in an array along a first direction and/or a second direction.

9. The head-up display system of claim 8, wherein the optical guides array has a multi-layered structure.

10. The head-up display system of claim 8, wherein two sub optical guides adjacent to each other in the optical guides array form an overlapping field of view.

11. The head-up display system of claim 1, wherein two adjacent optical guides contact with each other or a gap is between the two adjacent optical guides.

12. The head-up display system of claim 2, wherein the coupling in area and/or the coupling out area are one-dimensional gratings or two-dimensional gratings.

13. The head-up display system of claim 1, wherein the optical guides further comprise a turning area, the incident light passes through the coupling in area, the turning area and the coupling out area to form the exit light.

14. The head-up display system of claim 1, wherein the head-up display system has one light source or a plurality of light sources, and
wherein when the head-up display system has a plurality of light sources, the plurality of light sources are disposed corresponding to the optical guides, respectively.

15. A vehicle comprising the head-up display system according to claim 1, and the transmission-reflection plate is a vehicle windshield.
